(19) United States
(12) Patent Application Publication
(10) Pub. No.: US 2008/0054210 A1
(43) Pub. Date: Mar. 6, 2008

(54) Valve cartridge

(76) Inventor: Matthew S. Smith, Westlake, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/513,552

(22) Filed: Aug. 31, 2006

(51) Int. Cl. F16K 5/10

(52) U.S. Cl. 251/208

(57) ABSTRACT

A valve cartridge includes a housing having a bore. A fixed control disc and a rotatable control disc are provided in the bore. A shaft extends through the bore, and rotation of the shaft serves to rotate the rotatable control disc relative to the fixed control disc. The shaft is seated in said bore using at least one bushing. The at least one bushing serves in spacing the shaft from the housing, and provides for the smooth rotation of the shaft relative to the housing.

### TECHNICAL FIELD

Generally, the present invention is directed to a valve cartridge for a faucet. More specifically, the present invention is directed to a valve cartridge incorporating valving components to control the flow of water therethrough. More specifically, the present invention is directed to valving components for a valve cartridge incorporating bushings serving to limit friction and absorb axial and lateral loads generated during actuation of the valve cartridge.

### BACKGROUND

Typically, two-handle faucets include two valve cartridges used to separately control the flow of hot water and cold water through the faucet. The valve cartridges each include a housing and various valving components for controlling the flow of water through the housing. The valving components can, for example, include a fixed control disc, a rotatable control disc, and a shaft. The fixed control disc and the rotatable control disc each include various ports, and the shaft serves to rotate the rotatable control disc relative to the fixed control disc. Depending on the amount of rotation of the rotatable control disc relative to the fixed control disc, and the corresponding degree of alignment of the ports, varying amounts of water are permitted to flow through the valve cartridge.

Given that the shaft rotates within the housing, the shaft is subject to axial and lateral loads and friction is generated between the housing and the shaft. The axial and lateral loads, as well as friction, can cause wear between the housing and the shaft, and correspondingly limit the smooth rotation of the shaft within the housing and cause premature failure of the valve cartridge. Previously, grease and other lubricating materials, such as a combination of metallic and polymeric materials, have been utilized for the housing and the shaft to limit the effects of the axial and lateral loads and of friction. However, when the housing and the shaft are composed of metallic materials, grease has limited long-term effectiveness in preventing wear between the housing and the shaft. Furthermore, consumers, especially institutional buyers, tend to prefer purchasing faucets with valve cartridges having the housings and the shafts composed of metallic components.

As such, there is a need for a valve cartridge providing for the continued smooth rotation of the shaft within the housing by absorbing the axial and lateral loads and limiting friction generated during actuation of the valve cartridge without the need for grease or other lubricating materials for the housing and the shaft.

### SUMMARY

The present invention contemplates a valve cartridge having a housing having a bore, a shaft extending through the bore, and at least one bushing received on the shaft to space the shaft from the housing, the at least one bushing providing for the smooth rotation of the shaft relative to the housing.

The present invention further contemplates a valve cartridge having a housing having a bore, a fixed control disc provided in the bore, a rotatable control disc provided in the bore, a shaft extending through the bore, wherein rotation of the shaft serves to rotate the rotatable control disc relative to the fixed control disc, and at least one bushing serving to space the shaft from the housing to provide for the smooth rotation of the shaft relative to the housing.

The present invention still further contemplates a valve cartridge having a housing defining a bore, at least one bushing, and a shaft seated in the bore using the at least one bushing, wherein the bushing serves to space the housing and the shaft apart from one another.

Further embodiments, variations, and enhancements are also described herein.

### BRIEF DESCRIPTION OF THE DRAWINGS

FIG. 1 is a perspective exploded view of a faucet including a valve cartridge according to the present invention;

FIG. 2 is an enlarged front elevational view of the valve cartridge depicted in FIG. 1;

FIG. 3 is a cross-sectional view of the valve cartridge taken along Line 3-3 of FIG. 2; and

FIG. 4 is an enlarged perspective partially exploded view of a shaft incorporated in the valve cartridge of the present invention.

### DETAILED DESCRIPTION

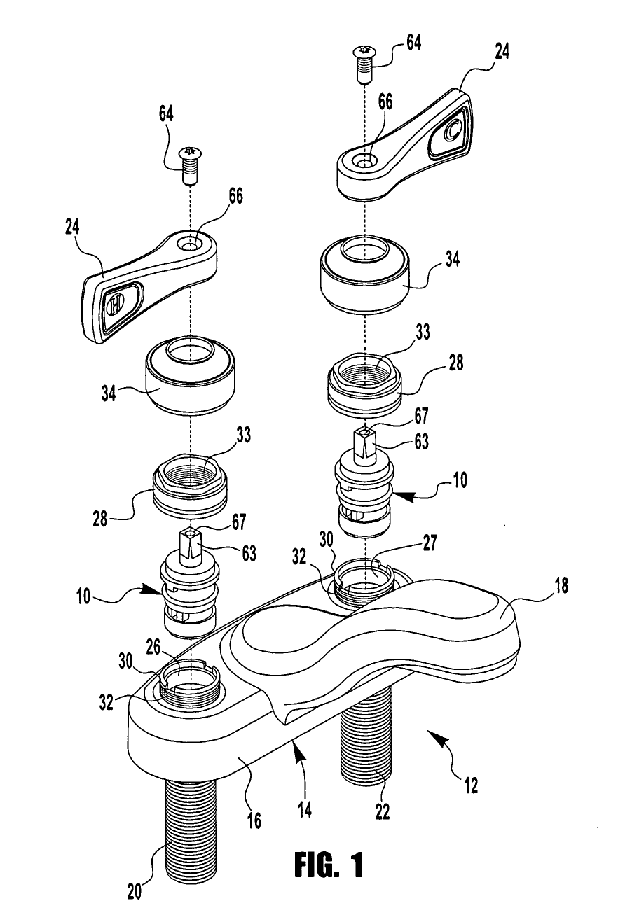

The valve cartridge according to the present invention is generally indicated by the numeral 10 in the accompanying drawings. As shown in FIG. 1, two of the valve cartridges 10 are incorporated in a two-handle faucet 12 to control the flow of water exiting the faucet 12. As such, one of the valve cartridges 10 is used to control the flow of hot water through the faucet 12 and one of the valve cartridges 10 is used to control the flow of cold water through the faucet 12.

As shown in FIG. 1, the faucet 12 includes a faucet body 14 formed by an escutcheon 16 and a spout 18. A hot water inlet pipe nipple 20 and a cold water inlet pipe nipple 22 are integrally formed with the escutcheon 16, and are respectively connected with hot and cold water supply pipes (not shown). Water from the hot and cold water supply pipes flows through a hot water passageway (not shown) formed through the hot water inlet pipe nipple 20 and a cold water passageway (not shown) formed through the cold water inlet pipe nipple 22. The valve cartridges 10, via actuation of handles 24, control the flow of water from the hot water passageway and the cold water passageway into a mixing chamber (not shown) formed in the escutcheon 16. The mixing chamber is used to mix water from the hot and cold supply pipes flowing through the valve cartridges 10 before the mixed water exits the spout 18 through a spout passageway (not shown).

The valve cartridges 10 control the volume of hot and cold water flowing from the hot and cold water supply pipes into the mixing chamber, and, in doing so, control the temperature of the mixed water ultimately exiting the faucet 12. As shown in FIG. 1, one of the valve cartridges 10 is associated with an aperture 26 provided in the escutcheon 16 and one of the valve assemblies 14 is associated with an aperture 27 provided in the escutcheon 16. The valve cartridge 10 provided in the aperture 26 controls the volume of hot water flowing into the mixing chamber and the valve cartridge 10 provided in the aperture 27 controls the volume of cold water flowing into the mixing chamber.

The valve cartridges 10 are received in the apertures 26 and 27 and interface with shoulders (not shown) provided adjacent the outlets of the hot and cold water passageways. As discussed below, the valve cartridges 10 can be actuated between open and closed positions using the handles 24. When the valve cartridges 10 are closed, water from the hot and cold water passageways is prevented from exiting the valve cartridges 10. When the valve cartridges 10 are opened, water from the hot and cold water passageways is permitted to exit the valve cartridges 10. Furthermore, depending on the degree to which the valve cartridges 10 are opened, the volume of water from the hot and cold water passageways permitted to flow into the mixing chamber can be increased.

The valve cartridges 10 are maintained in position relative to the escutcheon 16 using cartridge retainers 28. The cartridge retainers 28 are received on collars 30 extending upwardly from the escutcheon 16. The collars 30 partially define the apertures 26 and 27 in which the valve cartridges 10 are received, and include exterior threads 32 provided to compliment threads 33 provided on the interior of the cartridge retainers 28. By maintaining the valve cartridges 10 in position relative to the escutcheon 16, the cartridge retainers 28 prevent water from escaping the faucet 12 through the apertures 26 and 27. To prevent damage thereto or removal thereof, hubs 34 can be provided to cover the valve cartridges 10 and the cartridge retainers 28.

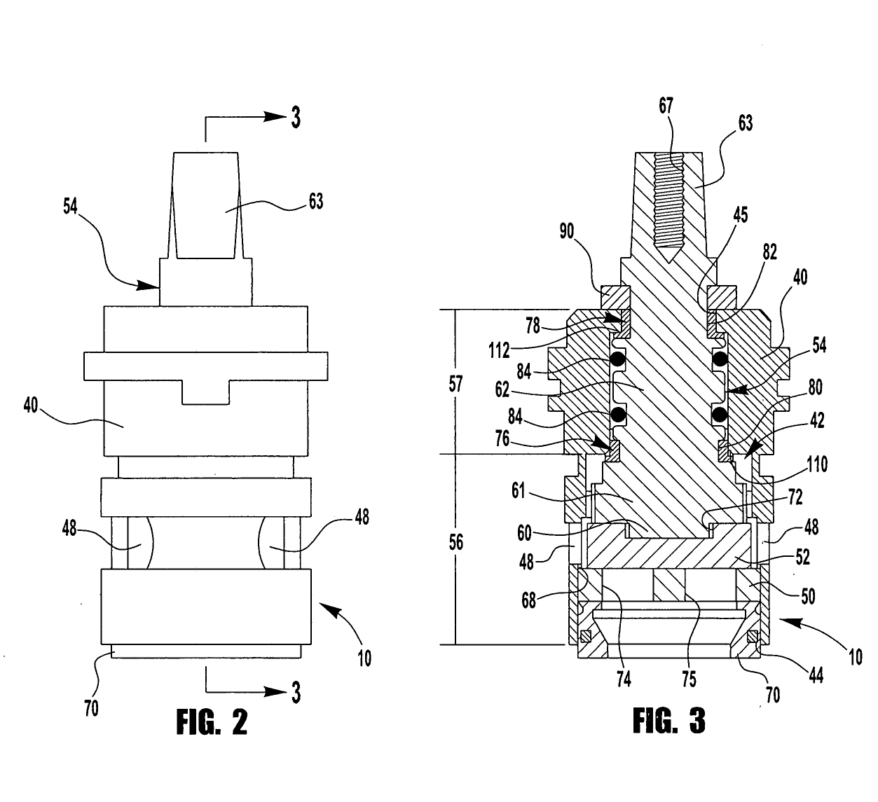

Each of the valve cartridges 10 includes a housing 40 that is generally cylindrical in shape (FIG. 2). The housing 40 can be composed of a metallic material such as brass, and includes a generally-cylindrical bore 42 extending therethrough that defines a first opening 44 and a second opening 45 in the housing 40. As discussed below, the bore 42 is provided to accommodate valving components generally indicated by the numeral 46 in FIG. 3. The valving components 46 can be actuated via actuation of the handles 24 to control the volume of water flowing through the valve cartridges 10. Water enters and exits each of the valve cartridges 10 though the first opening 44 (which serves as an inlet port) and various outlet ports 48, respectively. The various outlet ports 48 are formed through the housing 40, and the valving components 46 control the flow of water exiting each of the valves cartridges 10 through the various outlet ports 48.

The valving components 46 include a fixed control disc 50, a rotatable control disc 52, and a shaft 54. As defined in FIG. 3, the bore 42 includes a first section 56 provided adjacent the first opening 44 and a second section 57 provided adjacent the second opening 45. The fixed control disc 50 and the rotatable control disc 52 are disposed in the first section 56, and the shaft 54 extends from the first section 56 through the second section 57 (and the second opening 45) to the exterior of the housing 40.

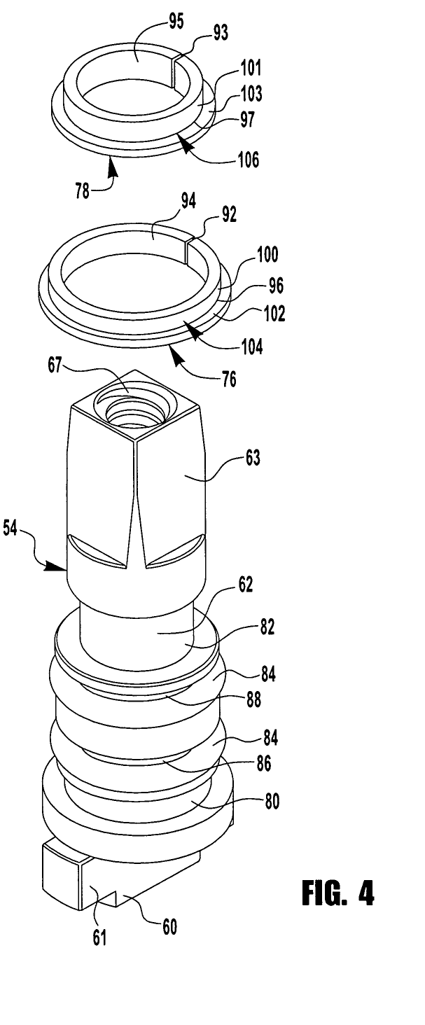

The shaft 54 can be composed of a metallic material such as brass, and, as shown in FIGS. 3 and 4, includes a tab 60, a base 61, a cylindrical section 62, and a stem 63. The shaft 54 is operatively connected to the rotatable control disc 50 using the tab 60 and the base 61, and the cylindrical section 62 serves in accommodating a first bushing 76 and a second bushing 78. As discussed below, the first bushing 76 and the second bushing 78 serve to absorb axial and lateral loads placed on the shaft 54 and to limit friction generated between the housing 40 and the shaft 54. Furthermore, to allow for the actuation of the valve cartridges 10, each of the stems 63 is attached to one of the handles 24. For example, a mechanical fastener 64 can be provided through an aperture 66 in the handle 24, and, thereafter, be received in a threaded aperture 67 formed in the stem 63 (FIG. 1).

As shown in FIG. 3, the fixed control disc 50 is maintained in position in the first section 56 adjacent an annular shoulder 68 formed along the surface of the first section 56 using a gasket 70. The gasket 70 is partially received in the first section 56, and, when the faucet 12 is assembled, interfaces with one of the shoulders provided adjacent the outlets of the hot and cold water passageways. For example, during assembly of the faucet 12, as the cartridge retainer 28 is screwed onto the collar 30, the gasket 70 is compressed against one of the shoulders provided adjacent the outlets of the hot and cold passageways and also compressed against the fixed control disc 50. As such, the gasket 70 serves in maintaining the fixed control disc 50 in position adjacent the annular shoulder 68 and limits rotation thereof relative to the housing 40. To further limit rotation of the first control disc 50 relative to the housing 40, the fixed control disc 50 can, if necessary, include anti-rotation lugs (not shown) received in channels (not shown) formed axially along the surface of the first section 56.

The rotatable control disc 52, as shown in FIG. 3, is maintained in position in the first section 56 between the fixed control disc 50 and the shaft 54. The rotatable control disc 52 includes a slot 72 provided to receive the tab 60. To operatively connect the shaft 54 to the rotatable control disc 52, the tab 60 is received in the slot 72, and the base 61 contacts the rotatable control disc 52. Because the shaft 54 is operatively connected to the rotatable control disc 52, rotation of the shaft 54 (via actuation of one of the handles 24) causes the rotatable control disc 52 to rotate relative to the fixed control disc 50. As discussed below, depending on the degree of rotation of the rotatable control disc 52 relative to the fixed control disc 50, the volume of water flowing through each of the valve cartridges 10 can be varied.

To control water flowing from the first opening 44 to the various outlet ports 48 through the housing 40, the fixed control disc 50 and rotatable control disc 52 each include oppositely-disposed triangular ports provided therethrough. As shown in FIG. 3, a first port 74 is formed in the right side of the fixed control disc 50 and a triangular port 75 is formed in the left side of the fixed control disc 50. Depending on the degree of rotation of the rotatable control disc 52 relative to the fixed control disc 50 (via actuation of one of the handles 24), the first and second ports 74 and 75 have varying degrees of communication with first and second ports (not shown) provided adjacent the edge of the rotatable control disc 52. When the first and second ports 74 and 75 are not aligned with the ports formed in the rotatable control disc 52, the valve cartridges 10 are closed. When the first and second ports 74 and 75 are aligned with the ports formed in the rotatable control disc 52, the valve cartridges 10 are opened. Furthermore, depending on the degree to which the first and second ports 74 and 75 are aligned with the ports formed in the rotatable control disc 52, the valves cartridges 10 can be increasingly opened.

As shown in FIG. 3, the cylindrical section 62 of the shaft 54 extends from the first section 56 through the second section 57 to the exterior of the housing 40, and has various diameters serving to define various grooves (FIGS. 3 and 4). The first bushing 76 and the second bushing 78 are provided in grooves 80 and 82, respectively, and o-rings 84 are provided in grooves 86 and 88. Additionally, a spring clip 90 (FIG. 3) can be provided in groove 82, to maintain the shaft 54 in position relative to the housing 40. The o-rings 84 seal against the surface of the second section 57 to prevent water from escaping the housing 40 through the second opening 45. Furthermore, the first bushing 76 and the second bushing 78 interface with surfaces provided in the bore 42, and, if necessary include expansion gaps 92 and 93, respectively. The expansion gaps 92 and 93 allow the first bushing 76 and the second bushing 78 to expand during placement thereof in the grooves 80 and 82, respectively.

The first bushing 76 and the second bushing 78 are provided to absorb axial and lateral loads placed on the shaft 54 and limit friction generated between the housing 40 and the shaft 54. In doing so, the first bushing 76 and the second bushing 78 prevent wear between the housing 40 and the shaft 54, and allow for the continued smooth rotation of the shaft 54 relative to the housing 40. The first bushing 76 and the second bushing 78 are composed of polymeric materials such as thermoplastics. For example, the first bushing 76 and the second bushing 78 can be composed of acetal copolymer. An example of acetal copolymer is manufactured under the trademark CELCON®. As shown in FIG. 3, the first bushing 76 and the second bushing 78 have L-shaped cross-sections. The L-shaped cross-sections are defined, in part, by inner surfaces 94 and 95 and outer surfaces 96 and 97 (FIG. 4). The inner surfaces 94 and 95 are cylindrical, and the outer surfaces 96 and 97 include cylindrical segments 100 and 101 and annular segments 102 and 103, respectively, defining annular channels 104 and 106.

As shown in FIG. 3, the inner surfaces 94 and 95 interface with the cylindrical surfaces of the grooves 80 and 82, respectively. Furthermore, the annular channels 104 and 106 receive annular shoulders 110 and 112 formed along the surface of the bore 42. The annular shoulder 110 can be formed at the intersection of the first section 56 and the second section 57, and the annular shoulder 112 can be formed adjacent the second opening 45. By receiving the annular shoulders 110 and 112 in the channels 104 and 106, respectively, the first bushing 76 and the second bushing 78 are seated in the bore 42, and serve in spacing the shaft 54 from the housing 40. As such, the first bushing 76 and the second bushing 78 serve to absorb axial and lateral loads placed on the shaft 54 and limit friction generated between the housing 40 and the shaft 54. In doing so, the first bushing 76 and the second bushing 78 serve to limit metal-to-metal contact between the housing 40 and the shaft 54, and to the limit the attendant wear caused thereby. As such, the first bushing 76 and the second bushing 78 provide for the continued smooth rotation of the shaft 54 during actuation of the valve cartridge 10.

While in accordance with the Patent Statutes, only the best mode and exemplary embodiments have been presented and described in detail, it is to be understood that the invention is not limited thereto or thereby.

1. A valve cartridge, comprising:
a housing having a bore;
a shaft extending through said bore; and
at least one bushing received on said shaft to space said shaft from said housing, said at least one bushing providing for the smooth rotation of said shaft relative to said housing.

2. A valve cartridge according to claim 1, further comprising a fixed control disc and a rotatable control disc provided in said bore, wherein rotation of said shaft serves to rotate said rotatable control disc relative to said fixed control disc.

3. A valve cartridge according to claim 2, wherein, depending on the degree of rotation of said rotatable control disc relative to said fixed control disc, varying amounts of water can flow through the valve cartridge.

4. A valve cartridge according to claim 3, wherein said housing includes an inlet port and at least one outlet port formed therein, and rotation of said rotatable control disc relative to said fixed control disc serves to control the amount of water passing from said inlet port to said at least one outlet port.

5. A valve cartridge according to claim 1, wherein said at least one bushing is composed of a polymeric material.

6. A valve cartridge according to claim 1, wherein said shaft is seated in said bore using said at least one bushing.

7. A valve cartridge according to claim 1, wherein said housing and said shaft are composed of metallic materials, and said at least one bushing serves to prevent metal-to-metal contact of said housing and said shaft.

8. A valve cartridge according to claim 1, wherein said at least one bushing is seated in said bore to space said housing and said shaft apart from one another.

9. A valve cartridge according to claim 1, wherein said bore includes an annular shoulder, and said at least one bushing contacts said annular shoulder to prevent contact between said housing and said shaft.

10. A valve cartridge according to claim 9, wherein said at least one bushing has an annular channel formed therearound, and said annular shoulder is received in said annular channel.

11. A valve cartridge, comprising:
a housing having a bore;
a fixed control disc provided in said bore;
a rotatable control disc provided in said bore;
a shaft extending through said bore, wherein rotation of said shaft serves to rotate said rotatable control disc relative to said fixed control disc; and
at least one bushing serving to space said shaft from said housing to provide for the smooth rotation of said shaft relative to said housing.

12. A valve cartridge according to claim 11, wherein said at least one bushing is composed of a polymeric material.

13. A valve cartridge according to claim 11, wherein said shaft is seated in said bore using said at least one bushing.

14. A valve cartridge according to claim 11, wherein said housing and said shaft are composed of metallic materials, and said at least one bushing serves to prevent metal-to-metal contact of said housing and said shaft.

15. A valve cartridge according to claim 11, wherein said at least one bushing is seated in said bore to space said housing and said shaft apart from one another.

16. A valve cartridge according to claim 11, wherein two bushings are provided along said shaft to space said shaft from said housing, each of said bushings contacting an annular shoulder formed in said bore.

17. A valve cartridge according to claim 16, wherein one of said bushings is provided adjacent the center of said shaft, and the other of said bushings is provided adjacent one end of said shaft.

18. A valve cartridge, comprising:
a housing defining a bore;
at least one bushing; and
a shaft seated in said bore using said at least one bushing, wherein said bushing serves to space said housing and said shaft apart from one another.

19. A valve cartridge according to claim 18, wherein said bore includes an annular shoulder, and said at least one bushing contacts said annular shoulder to prevent contact between said housing and said shaft.

20. A valve cartridge according to claim 19, wherein said at least one bushing has an annular shoulder provided therearound, and said annular shoulder is received in said annular channel.
